(19) United States
(12) Patent Application Publication
(10) Pub. No.: US 2014/0314955 A1
(43) Pub. Date: Oct. 23, 2014

(54) DEPOSITION APPARATUS

(71) Applicant: Samsung Display Co., Ltd., Yongin-city (KR)

(72) Inventors: Sang-Min Jung, Yongin-city (KR); Jung-Woo Hwang, Yongin-city (KR)

(73) Assignee: Samsung Display Co., Ltd., Yongin-city (KR)

(21) Appl. No.: 14/041,061

(22) Filed: Sep. 30, 2013

(30) Foreign Application Priority Data
Apr. 18, 2013 (KR) 10-2013-0043040

(51) Int. Cl. B05B 15/04; B05D 1/32

(52) U.S. Cl. CPC B05B 15/045; B05D 1/32
USPC 427/282; 118/504

(57) ABSTRACT

A deposition apparatus includes: a deposition chamber; a deposition source in the deposition chamber; a film fixing portion configured to fix a film, provided with a deposition surface to which the deposition material is deposited; and a protection plate in the deposition chamber to prevent the deposition material from being deposited to side and upper walls in the deposition chamber so as to control the deposition material to be deposited only to a valid film formation area. A first opening sized to correspond to the valid film formation area of the deposition surface and at least one second opening formed in an external area of the valid film formation area are formed in the protection plate, and, when the deposition material is deposited to the deposition surface by the deposition source, the deposition material passed through the second opening forms an alignment mark on the deposition surface.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to and the benefit of Korean Patent Application No. 10-2013-0043040 filed in the Korean Intellectual Property Office on Apr. 18, 2013, the entire contents of which are incorporated herein by reference.

### BACKGROUND

1. Field

The described technology relates generally to a deposition apparatus that can deposit a deposition material on a film.

2. Description of the Related Technology

Among display devices, an organic light emitting display has a wide viewing angle, excellent contrast, and a fast response speed, and thus it been in the limelight as the next-generation display device.

An organic light emitting diode (OLED) display typically includes a first electrode, a second electrode, an emission layer disposed between the first electrode and the second electrode, and an intermediate layer including the emission layer. The first and second electrodes and the intermediate layer may be formed using various methods, and among the various methods, an independent deposition method may be used.

In order to manufacture the OLED display using the independent deposition method, a fine metal mask (FMM) having the same pattern of a thin film is closely attached to a substrate where the thin film is expected to be formed, and a material such as a thin film is deposited such that a film having a predetermined pattern is formed.

Until recently, an organic thin film has generally been formed using the fine metal mask (FMM), but a precise pattern shape cannot be deposited if the size of a glass substrate is greater than the size of a sixth generation substrate.

Accordingly, a laser induced thermal imaging (LITI) method has emerged as a method for forming an organic material further more precise than the FMM by disposing a donor film facing a glass substrate and irradiating laser beams, and recently, a hybrid patterning system (HPS) method employing both of the FMM method and the LITI method has been researched and developed.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

According to one aspect to the present invention, a deposition apparatus configured to deposit a deposition material on a film is provided. The deposition apparatus includes: a deposition chamber; a deposition source in the deposition chamber; a film fixing portion configured to fix a film, the film fixing portion including a deposition surface to which the deposition material is deposited; and a protection plate in the deposition chamber configured to prevent the deposition material from being deposited to side and upper walls in the deposition chamber. A first opening sized to correspond to a valid film formation area on the deposition surface and at least one second opening formed in an external area of the valid film formation area are formed on the protection plate, and, the deposition material passing through the at least one second opening forms an alignment mark on the deposition surface.

The at least one second opening comprises a plurality of second openings, and the plurality of second openings may be disposed adjacent to circumference perimeter of the first opening.

The first opening may be formed in the shape of a quadrangle, and the plurality of second openings may be disposed adjacent to corners of the first opening.

Each of the second openings may be formed in the shape of a cross.

The film fixing portion may include a frame supporting the film and a support fixing the frame to the deposition chamber.

A third opening sized wider than the valid film formation area of the deposition surface may be formed in the frame, and the first opening and the plurality of second openings may be disposed in the third opening when viewed from from the deposition source.

In this case, the deposition source may be disposed on a bottom surface of the deposition chamber.

The film fixing portion may be provided in an upper side of the deposition chamber, and, the protection plate may include a first protection plate disposed in a lower side of the film fixing portion and a second protection plate configured to protect a side surface in the deposition chamber.

The first opening may be disposed in a center of the deposition chamber.

According to another aspect to the present invention, a method for depositing a deposition material on a film is disclosed. The method includes: placing a deposition source in a deposition chamber; depositing a deposition material through a first opening of a protection plate in the deposition chamber and onto a valid film formation on the deposition surface of a film fixing portion without depositing the deposition material to side and upper walls in the deposition chamber; depositing the deposition material through a second opening of the protection plate, to form an alignment mark on the deposition surface outside of the valid film formation area; and fixing the film on the valid film formation area of the film fixing portion.

The method may include depositing the deposition material through a plurality of second openings disposed adjacent to the perimeter of the first opening.

The first opening may be formed in the shape of a quadrangle, and the deposition material may be deposited through the plurality of second openings disposed adjacent to corners of the first opening.

Each of the second openings may be formed in the shape of a cross.

The film fixing portion may include a frame supporting the film and a support fixing the frame to the deposition chamber.

The method may further include depositing the deposition material through a third opening sized wider than the valid film formation area of the deposition surface formed in the frame, and the first opening and the plurality of second openings are disposed in the third opening when viewed from the deposition source.

The deposition source may be disposed on a bottom surface of the deposition chamber.

The film fixing portion may be provided in an upper side of the deposition chamber, and the protection plate may include: a first protection plate disposed in a lower side of the film fixing portion, and a second protection plate configured to protect a side surface in the deposition chamber.

The first opening may be disposed in a center of the deposition chamber.

The deposition material may be an organic material.

According embodiments of the present invention, a deposition material is deposited to a deposition surface of a film by a deposition source. In this case, an alignment mark may be formed together in an area other than a valid film formation area in the film so that the thickness of the film can be further precisely measured using the align mark.

### BRIEF DESCRIPTION OF THE DRAWINGS

FIG. 1 is a schematic diagram of a deposition apparatus according to an embodiment.

FIG. 2 is a partial perspective view of a film fixing portion to which a film is fixed and a protection plate of the deposition apparatus according to an embodiment.

FIG. 3 shows a state in which a deposition material is deposited to a film by the deposition apparatus according to an embodiment.

### DETAILED DESCRIPTION OF CERTAIN INVENTIVE EMBODIMENTS

In the following detailed description, only certain embodiments have been shown and described, simply by way of illustration. As those skilled in the art would realize, the described embodiments may be modified in various ways, without departing from the spirit or scope of the present invention. The drawings and description are to be regarded as illustrative in nature and not restrictive. Like reference numerals generally designate like elements throughout the specification.

The HPS process includes a process for forming an organic material on a film fastened to a separate tray of a glass substrate in the film deposition apparatus. Like the glass substrate, an ellipsometer is used as a film thickness measurer to monitor the thickness of a deposition film.

However, unlike the glass substrate, an alignment mark is not provided in the film, and therefore, location reproducibility and iteration accuracy with respect to a measurement point cannot be assured in measurement of film thickness because a means for aligning the tray is not provided in the ellipsometer and reliability with respect to a measurement result may be deteriorated.

The described technology has been made in an effort to provide a deposition apparatus that can accurately measure a film thickness of an organic material deposited to a film.

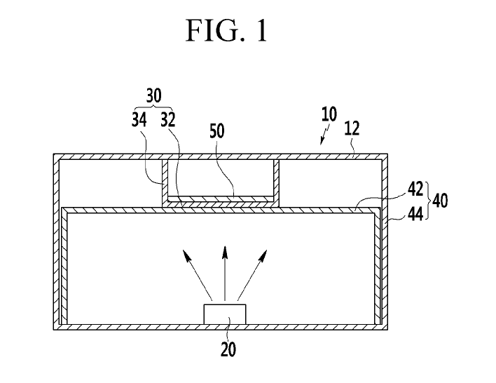

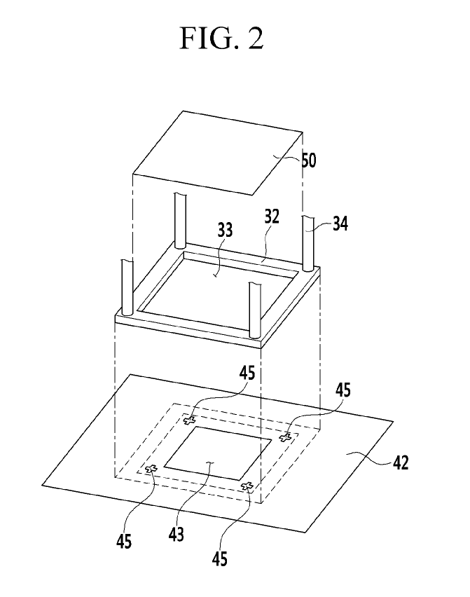

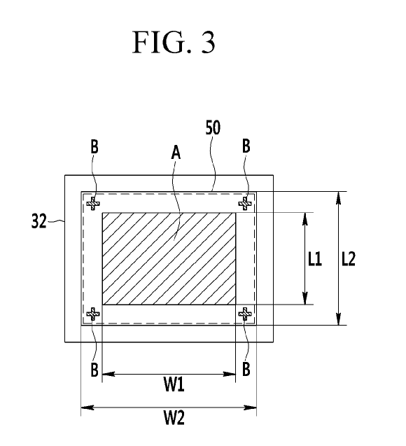

FIG. 1 is a schematic diagram of a deposition apparatus according to an embodiment. FIG. 2 is a partial perspective view of a film fixing portion to which a film is fixed and a protection plate in the deposition apparatus according to an embodiment. FIG. 3 shows a state in which a deposition material is deposited to a film by the deposition apparatus according to an embodiment.

Referring to FIG. 1 and FIG. 2, a deposition apparatus 10 according to an embodiment deposits a deposition material on a film, and includes a deposition chamber 12, a deposition source 20, a film fixing portion 30, and a protection plate 40.

The deposition chamber 12 surrounds a space to which a film 50 is deposited, and may be formed as a hexahedral-shaped housing including the deposition source 20 and the film fixing portion 30 therein as shown in FIG. 1.

Although it is not illustrated in FIG. 1, an inlet hole through which the film 50 can enter the deposition chamber and an outlet hole through which the film 50 can be discharged to the outside from the deposition chamber 12 may be formed in the deposition chamber 12.

A transfer means (not shown) may also be provided to transfer the film 50 in the deposition chamber 12.

The film fixing portion 30 is provided in an inner upper center surface of the deposition chamber 12. The film fixing portion 30 includes a frame 32 and supports 34.

The frame 32 is formed in the shape of a quadrangle so that the film 50 that may be formed in the shape of a quadrangle can be mounted thereto, and an opening 33 is formed in an inner side of the frame 32. The deposition material can be deposited to the bottom surface of the film 50 in a state that the film 50 is mounted to the frame 32 through the opening 33 formed in the frame 32.

The quadrangle-shaped frame 32 is fixed to the upper surface of the deposition chamber 12 by the supports 34 formed in the four corners thereof.

The film 50 mounted to the frame 32 may be formed in the shape of a quadrangle, and the film 50 according to an embodiment is transferred into the deposition chamber 12 through the inlet hole (not shown) and then mounted to the frame 32.

In this case, the size of the film 50 may have a width of W2 and a height of L1 as shown in FIG. 3, and such a size of the film 50 may be wider than the width of the opening 33 formed in the frame 32. As described, the film 50 can be disposed on the frame 32 while wholly covering the opening 33 when the size of the film 50 is greater than the opening 33 formed in the frame 32.

The frame 32 is formed in the shape of a quadrangle to fix the film 50, and the film 50 is fixed to the upper surface in the deposition chamber by the four supports 34, but the shapes of the frame and the support can be variously modified as long as they can fix the film 50.

According to an embodiment, the deposition source 20 is provided in a center of an inner bottom surface of the deposition chamber 12.

The deposition source 20 supplies the deposition material to a direction of the film provided in the upper side of the deposition chamber 12 for deposition of the deposition material to the film 50.

According to an embodiment, the deposition material deposited to the film 50 may be an organic material.

According to an embodiment, the protection plate 40 is provided in the deposition chamber 12.

The protection plate 40 is provided in the deposition chamber 12 for controlling deposition to be performed only in a valid film formation area, A, when the deposition occurs in the film 50 by the deposition source 20 and controlling a deposition material not to be deposited to upper and side walls in the deposition chamber 12.

According to an embodiment, the protection plate 40 may include a first protection plate 42 for protection of an upper surface of the deposition chamber 12 and a second protection plate 44 for protection side surfaces of the deposition chamber 12.

According to an embodiment, the first protection plate 40 is provided in a lower side of the film fixing portion and may be formed in the shape of a rectangular square. In this case, referring to FIG. 2, a first opening 43 and second openings 45 are formed the first protection plate 40.

In one embodiment, the first opening 43 is formed in a size that corresponds to an area (hereinafter, a valid film formation area) to which the deposition material is deposited in a deposition surface, which is a bottom surface of the film. In this embodiment, as shown in FIG. 2 and FIG. 3 the first opening 43 may be formed in the shape of a rectangular having a width W1 and a width L1, but the shape of the first opening 43 is not limited thereto.

The second opening 45 is provided to form an alignment mark on the deposition surface to which the deposition material is deposited by the deposition source 20. The second opening 45 is formed in an external side of the valid film formation area A.

The second opening 45 may be provided in plural, and in one embodiment, the second opening 45 includes four second openings 45. Each of the second openings 45 is provided in an external side of each of four corners of the rectangular-shaped first opening 43, and may be formed in the shape of a cross.

In this case, according to one embodiment, the second openings 45 may be disposed adjacent to the circumference of the first opening 43.

According to one embodiment, an opening 33 (hereinafter, formed in a third opening 33) formed in the frame is formed wider than the valid film formation area A formed in the deposition surface of the film 50, and the first and second openings 43 and 45 are disposed in the third opening 33 in a view from a direction (i.e., a lower side direction in FIG. 1) where the deposition source 20 is disposed.

As described, since the third opening 33 is formed wider than the width including the first and second openings 43 and 45, when the deposition material is discharged toward the film 50 by the deposition source 20 while the film 50 is supported by the frame, the deposition material passed through the first opening 43 is deposited to the bottom surface of the film 50. The valid film formation area A of the deposition surface in the third opening 33 and the deposition material passed through the second opening 45 forms an alignment mark B that corresponds to the shape of the second opening 45 in a location close to the valid film formation area A in the third opening 33.

Accuracy for measurement of a film thickness of the valid film formation area A may be improved to dispose the alignment mark B to be closer to the valid film formation area A, but the location and the shape of the alignment mark B may be changed depending on the size and the shape of the valid film formation area A.

In the deposition apparatus 10 according to one embodiment, the second opening 45 of the protection plate 40 is disposed in the third opening 33 that is formed in the frame 32 that supports the film 50, but it is not restrictive. The second opening 45 of the protection plate 40 may be disposed in an outer side of the frame 32.

The plurality of alignment marks B formed as the deposition material is disposed to the external side of the valid film formation area A of the film 50 during a process for depositing the deposition material on the film 50 may be used to determine a determine an original point, or to determine a measurement location through pattern matching in a process for forming the thickness of a film deposited to the film 50.

Accordingly, the alignment mark is formed at the periphery area of the valid film formation area on the film 50 using the deposition apparatus 10 so that location reproducibility and iteration accuracy during a process can be improved.

While this disclosure has been described in connection with certain embodiments, it is to be understood that the invention is not limited to the disclosed embodiments, but, on the contrary, is intended to cover various modifications and equivalent arrangements included within the spirit and scope of the appended claims.

Description of symbols

| | |
|---|---|
| 10 deposition apparatus | 12 deposition chamber |
| 20 deposition source | 30 film fixing portion |
| 32 frame | 33 third opening |
| 34 support | 40 protection plate |
| 42 first protection plate | 43 first opening |
| 44 second protection plate | 45 second opening |
| 50 film | |

What is claimed is:

1. A deposition apparatus configured to deposit a deposition material on a film, the apparatus comprising:
a deposition chamber;
a deposition source in the deposition chamber;
a film fixing portion configured to fix a film, the film fixing portion including a deposition surface to which the deposition material is deposited; and
a protection plate in the deposition chamber configured to prevent the deposition material from being deposited to side and upper walls in the deposition chamber,
wherein a first opening sized to correspond to a valid film formation area on the deposition surface and at least one second opening formed in an external area of the valid film formation area are formed on the protection plate, and
wherein the deposition material passing through the at least one second opening is configured to form an alignment mark on the deposition surface.

2. The deposition apparatus of claim 1, wherein the at least one second opening comprises a plurality of second openings and the plurality of second openings are disposed adjacent to a perimeter of the first opening.

3. The deposition apparatus of claim 2, wherein the first opening is formed in the shape of a quadrangle, and the plurality of second openings are disposed adjacent to corners of the first opening.

4. The deposition apparatus of claim 3, wherein each of the second openings is formed in the shape of a cross.

5. The deposition apparatus of claim 1, wherein the film fixing portion comprises:
a frame supporting the film and
a support fixing the frame to the deposition chamber.

6. The deposition apparatus of claim 5, wherein a third opening sized wider than the valid film formation area of the deposition surface is formed in the frame, and the first opening and the plurality of second openings are disposed in the third opening when viewed from the deposition source.

7. The deposition apparatus of claim 1, wherein the deposition source is disposed on a bottom surface of the deposition chamber.

8. The deposition apparatus of claim 1, wherein the film fixing portion is provided in an upper side of the deposition chamber, and wherein the protection plate comprises:
a first protection plate disposed in a lower side of the film fixing portion, and
a second protection plate configured to protect a side surface in the deposition chamber.

9. The deposition apparatus of claim 8, wherein the first opening is disposed in a center of the deposition chamber.

10. The deposition apparatus of claim 1, wherein the deposition material is an organic material.

11. A method for depositing a deposition material on a film, the method comprising:
placing a deposition source in a deposition chamber;
depositing a deposition material through a first opening of a protection plate in the deposition chamber and onto a valid film formation on the deposition surface of a film fixing portion without depositing the deposition material to side and upper walls in the deposition chamber;
depositing the deposition material through a second opening of the protection plate, to form an alignment mark on the deposition surface outside of the valid film formation area; and
fixing the film on the valid film formation area of the film fixing portion.

12. The method of claim 11, comprising depositing the deposition material through a plurality of second openings disposed adjacent to the perimeter of the first opening.

13. The method of claim 12, wherein the first opening is formed in the shape of a quadrangle, and wherein the deposition material is deposited through the plurality of second openings disposed adjacent to corners of the first opening.

14. The method of claim 13, wherein each of the second openings is formed in the shape of a cross.

15. The method of claim 11, wherein the film fixing portion comprises:
a frame supporting the film and
a support fixing the frame to the deposition chamber.

16. The method of claim 15, further comprising depositing the deposition material through a third opening sized wider than the valid film formation area of the deposition surface formed in the frame, and the first opening and the plurality of second openings are disposed in the third opening when viewed from the deposition source.

17. The method of claim 11, wherein the deposition source is disposed on a bottom surface of the deposition chamber.

18. The method of claim 11, wherein the film fixing portion is provided in an upper side of the deposition chamber, and wherein the protection plate comprises:
a first protection plate disposed in a lower side of the film fixing portion, and
a second protection plate configured to protect a side surface in the deposition chamber.

19. The method of claim 18, wherein the first opening is disposed in a center of the deposition chamber.

20. The method of claim 11, wherein the deposition material is an organic material.
